(19) United States
(12) Patent Application Publication
(10) Pub. No.: US 2016/0174741 A1
(43) Pub. Date: Jun. 23, 2016

(54) DRINKING STRAW FOR INFUSING BEVERAGE DURING CONSUMPTION

(71) Applicant: Stephanie A. Scarbrough, Winston, GA (US)

(72) Inventor: Stephanie A. Scarbrough, Winston, GA (US)

(21) Appl. No.: 14/924,846

(22) Filed: Oct. 28, 2015

Related U.S. Application Data
(60) Provisional application No. 62/096,032, filed on Dec. 23, 2014.

(51) Int. Cl. A47G 21/18; A23L 2/60

(52) U.S. Cl. CPC A47G 21/183; A23L 2/60; A23V 2002/00

(57) ABSTRACT

Disclosed are various embodiments of cups and straws for infusing a substance into a liquid during consumption. In one embodiment, the cup includes an elevated platform that comprises a perforated surface and a cavity for a straw. The elevated platform may be positioned in the cup to retain a collection of the substance. When the cup is filled with the liquid, the platform is configured to facilitate the substance dissolving consistently throughout the liquid. In another embodiment, the straw includes a main channel for liquid to flow and a reservoir retaining the substance. As suction is applied to the straw, the various embodiments illustrate methods for the substance to mix with liquid the substance as the liquid flows through the main channel of the straw.

### CROSS-REFERENCE TO RELATED APPLICATION

This application claims the benefit of and priority to co-pending U.S. Provisional Patent Application No. 62/096,032, entitled “INFUSING BEVERAGE DURING A CONSUMPTION,” filed Dec. 23, 2014, and U.S. patent application Ser. No. ______ (Attorney Docket No. 101902-1020), filed on Oct. 28, 2015, entitled “DRINKING STRAW WITH A RESERVOIR,” which are hereby incorporated by reference in their entirety herein.

### BACKGROUND

Many individuals may sweeten drinks by adding natural honey. Traditionally, honey is poured into a cup and stirred by the individual. Using this method, natural honey and other ingredients may present challenges such as clumping at the bottom of the cup, clogging a straw, and inconsistent sweetening. In some cases, individuals may prefer adding honey to a heated drink to avoid these problems. However, after the drink cools down, the drink may require reheating to prevent the honey from clumping again. After some time of heating, stirring, and reheating, the individual may find these efforts tiresome and still may be unsatisfied with the flavor of their drink.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows a drawing of a drinking straw having a reservoir that infuses an ingredient into a beverage during consumption according to various embodiments of the present disclosure.

FIG. 2 shows a side view of the drinking straw 100 of FIG. 1 according to various embodiments of the present disclosure.

FIG. 3 shows an exploded and disassembled view of the drinking straw 100 of FIG. 1 according to various embodiments of the present disclosure.

FIG. 4 shows a cross-section view of the drinking straw 100 of FIG. 1 according to various embodiments of the present disclosure.

FIG. 5 shows a disassembled cross-section view of the drinking straw 100 of FIG. 1 according to various embodiments of the present disclosure.

FIG. 6 shows an enhanced cross-section view of the drinking straw 100 of FIG. 1 according to various embodiments of the present disclosure.

FIG. 7 shows another enhanced cross-section view of the drinking straw 100 of FIG. 1 according to various embodiments of the present disclosure.

FIG. 8 shows an enhanced disassembled cross-section view of the drinking straw 100 of FIG. 1 according to various embodiments of the present disclosure.

FIG. 9 shows a disassembled cross-section view of the drinking straw 100 of FIG. 1 having a disc-shaped sweeting agent according to various embodiments of the present disclosure.

FIG. 10 shows a cross-section view of a perforated disc of the drinking straw 100 of FIG. 1 for placement of honey or other agent according to various embodiments of the present disclosure.

FIGS. 11A-11D shows embodiments where a reservoir of the drinking straw may be removed independently from tube portions of the drinking straw according to various embodiments of the present disclosure.

### DETAILED DESCRIPTION

The present disclosure relates to various methods and systems for mixing a drink with an agent, such as a sweetening, nutritional, or coloring agent, during consumption of the drink. As noted above, natural honey and other sweeteners can be used to sweeten a beverage to the taste of an individual. For example, tea drinkers commonly use natural honey to sweeten their drink. Often times the honey can clump or thicken at the bottom of the cup. This effect can be especially problematic for drinkers using a straw or adding honey to a cold beverage. The clumped honey may clog the straw or may make areas of the bottom of the cup sticky. Hence, tea drinkers generally stir their beverage to keep honey from clumping and/or to help the honey dissolve consistently throughout the beverage. Alternatively or in addition, tea drinkers may prefer to add honey to a heated beverage. In some cases, an individual may resort to reheating and/or persistent stirring to achieve a desired flavor and to keep the above-mentioned challenges from occurring. As such, these methods can be time-consuming and may still result in inconsistent sweetening.

According to various embodiments described herein, a drinking straw includes a reservoir for storage of an agent that infuses a beverage or other liquid with the agent as it consumed. In some embodiments, the drinking straw includes a reservoir disposed between a first elongated tube portion and a second elongated tube portion. In an example operation of the drinking straw, the second elongated tube portion may be placed into a liquid, such as a beverage. The operator can induce suction using her or her mouth in the first elongated tube portion which causes the liquid to be pulled through the second elongated tube portion into the reservoir. Assuming an agent has been placed in the reservoir, the liquid makes contact with the agent affecting its properties prior to traveling through the first elongated tube portion into the mouth of the operator. In various embodiments, the agent comprises a compound that affects the taste, flavor, color, or nutritional content of the liquid.

In various embodiments, the components of the drinking straw may be disassembled to facilitate cleaning the drinking straw, such as by placing the individual components in hot and soapy water or in a dishwasher, as well as allowing an operator to remove or insert agents into the interior of the reservoir. In various embodiments, the reservoir may comprise a top portion coupled to the first elongated tube portion and a bottom portion coupled to the second elongated tube portion. Further, the reservoir may comprise a perforated disc disposed between the top portion and the bottom portion to retain an agent while not substantially interfering with the flow of the liquid through the reservoir. In some embodiments, the agent comprises a sweetening agent, such as honey, and the liquid sucked through the drinking straw comprises tea or water.

In the following discussion, a general description of the drinking straw and its components is provided, followed by a discussion of the operation of the same.

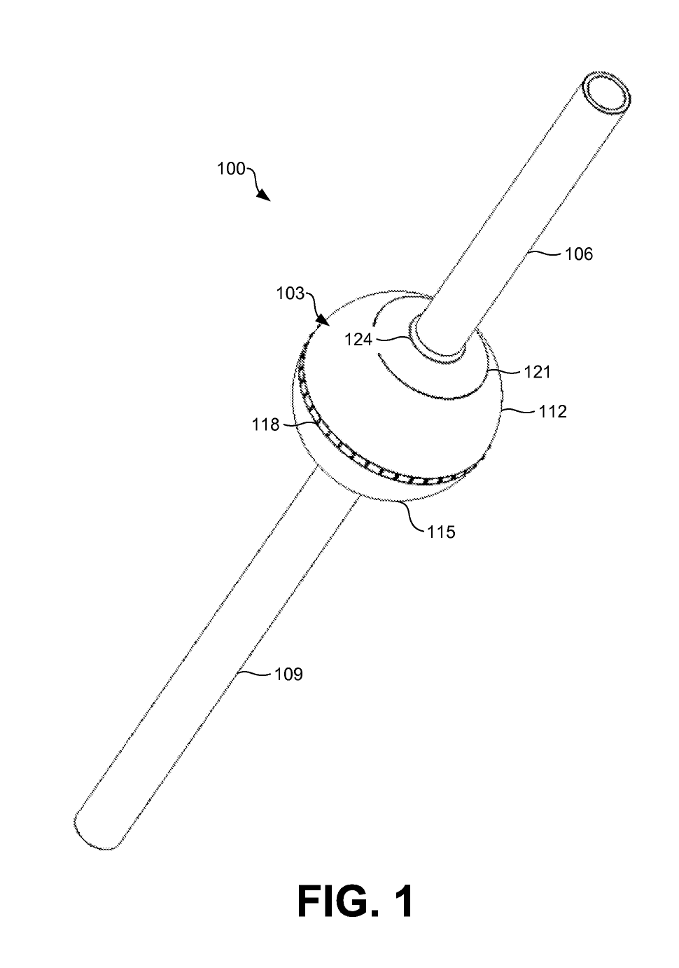

With reference to FIG. 1, shown is a non-limiting example of a drinking straw 100 having a reservoir 103 according to various embodiments of the present disclosure. In various embodiments, the drinking straw 100 may be described as having a first elongated tube portion 106 and a second elongated tube portion 109. As may be appreciated, the first elongated tube portion 106 may be positioned upwards for placement into a mouth of an operator to induce suction. The second elongated tube portion 109 may be positioned downwards for placement into a liquid.

In the non-limiting example of FIG. 1, the reservoir 103 is shown as being disposed between the first elongated tube portion 106 and the second elongated tube portion 109. The position of the reservoir 103 along a shaft of the drinking straw 100 may be adjusted based on the length of the first elongated tube portion 106 and the second elongated tube portion 109, as may be appreciated. In various embodiments, the reservoir 103 is employed to cause a liquid being sucked through the first elongated tube portion 106 and the second elongated tube portion 109 to mix with an agent retained in the reservoir 103 as liquid flows through the drinking straw 100. The reservoir 103 may be substantially spherical or ovular in shape, although in other embodiments, the reservoir 103 may assume other shapes.

In some embodiments, the reservoir 103 may be described as having a top portion 112 and a bottom portion 115. The top portion 112 may be detachably attached or otherwise coupled to the first elongated tube portion 106 while the bottom portion 115 may be detachably attached or otherwise coupled to the second elongated tube portion 109. Additionally, the top portion 112 may be detachably attached or otherwise coupled to the bottom portion 115, thereby forming a fully assembled drinking straw 100.

In some embodiments, a perforated disc 118 may be disposed between the top portion 112 and the bottom portion 115 of the reservoir 103 and may have sides exposed on the outer surface of the drinking straw 100. In various embodiments, the exposed sides of the perforated disc 118 comprise ridges or other projected features that facilitate gripping or rotating the perforated disc 118 to detach the top portion 112 and/or the bottom portion 115 from the perforated disc 118.

In embodiments where the top portion 112 is detachably attached to the first elongated tube portion 106, a tube base 121 may be configured to detach from the top portion 112. In some embodiments, the tube base 121 may comprise a receptacle 124 configured to receive the first elongated tube portion 106.

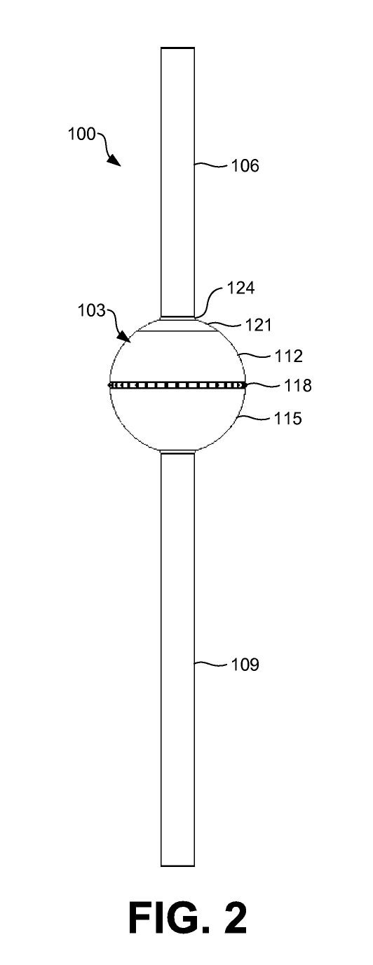

Referring next to FIG. 2, shown is side view of the drinking straw of FIG. 1 according to various embodiments of the present disclosure. As noted above, the drinking straw 100 may comprise a first elongated tube portion 106 and a second elongated tube portion 109 where the second elongated tube portion 109 may be used for placement into a liquid while the first elongated tube portion 106 may be used for insertion into a mouth of an operator to induce suction of the liquid through the drinking straw 100. As shown in FIG. 2, the reservoir 103 may be disposed between the first elongated tube portion 106 and the second elongated tube portion 109 where the reservoir 103 is configured to cause the liquid being sucked through the first elongated tube portion 106 and the second elongated tube portion 109 to mix with an agent retained in the reservoir 103 as liquid flows through the drinking straw 100.

In various embodiments, the reservoir 103 comprises the top portion 112, the perforated disc 118, and the bottom portion 115. The top portion 112 may be detachably attached or otherwise coupled to the first elongated tube portion 106 while the bottom portion 115 may be detachably attached or otherwise coupled to the second elongated tube portion 109. Additionally, the top portion 112 may be detachably attached or otherwise coupled to the bottom portion 115, thereby forming a uniform and fully assembled drinking straw 100. Also noted above, in some embodiments, the perforated disc 118 is exposed on the outer surface of the drinking straw 100. The perforated disc 118 may comprise ridges or other projected features that facilitate gripping or rotating the perforated disc 118 to detach the top portion 112 from the bottom portion 115.

In embodiments where the top portion 112 is detachably attached to the first elongated tube portion 106, the tube base 121 may be configured to detach from the top portion 112. In some embodiments, the tube base 121 may comprise the receptacle 124 configured to receive the first elongated tube portion 106.

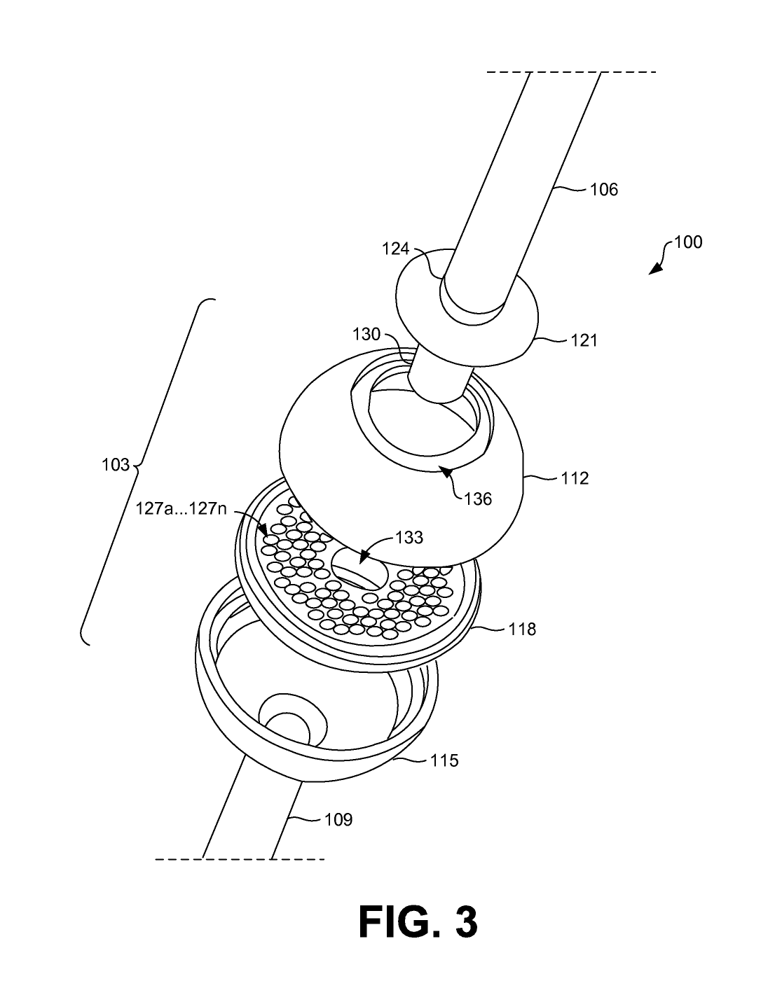

Turning now to FIG. 3, shown is a disassembled view of the drinking straw 100 according to various embodiments of the present disclosure. As noted above, the drinking straw 100 may comprise a first elongated tube portion 106 and a second elongated tube portion 109 where the second elongated tube portion 109 may be used for placement into a liquid while the first elongated tube portion 106 may be used for insertion into a mouth of an operator to induce suction of the liquid through the drinking straw 100. The reservoir 103 of the drinking straw 100 may be disposed between the first elongated tube portion 106 and the second elongated tube portion 109 where the reservoir 103 is configured to cause the liquid being sucked through the first elongated tube portion 106 and the second elongated tube portion 109 to mix with a substance, such as a sweetening agent, retained in the reservoir 103 as liquid flows through the drinking straw 100.

The reservoir 103 of FIG. 3 is shown with the individual components disassembled from one another. For example, the top portion 112, the perforated disc 118, and the bottom portion 115 are shown as being distinct and separate components. To connect the individual components to form a uniform and fully assembled drinking straw 100, the top portion 112 may be detachably attached to the first elongated tube portion 106 while the bottom portion 115 may be detachably attached to the second elongated tube portion 109. Additionally, the top portion 112 may be detachably attached or otherwise coupled to the perforated disc 118 and/or bottom portion 115.

In various embodiments, the perforated disc 118 may comprise a perforated disc or similar component where a plurality of perforations 127a . . . 127n or holes exist, allowing liquid to proceed from the bottom portion 115 to the top portion 112 when suction is induced in the first elongated tube portion 106. Further, the top portion 112 of the drinking straw 100 may be detachably attached to the first elongated tube portion 106 via a tube base 121 that is configured to detach from the top portion 112. To this end, a bottom end 130 of the first elongated tube portion 106 may extend beyond the tube base 121 and through a recess 133 of the perforated disc 118. The tube base 121 may comprise the receptacle 124 configured to receive the first elongated tube portion 106. Further, the tube base 121 may be configured to snap into or otherwise detachably attach to a recess 136 of the top portion 112 of the reservoir 103.

In various embodiments, an inside of the bottom portion 115, the perforated disc 118, and/or the top portion 112 may be threaded to allow for the components to be assembled by screwing together individual components. For example, a male thread of the perforated disc 118 may be screwed into a female thread of the bottom portion 115 and/or the top portion 112 of the reservoir 103. Similarly, the tube base 121 may comprise threads to be received in a threaded form of the recess 136 of the top portion 112 of the reservoir 103.

In various embodiments, the perforated disc 118 is configured to retain or support an agent or other substance that may affect the taste, nutritional content, and/or color of a liquid being sucked through the drinking straw 100. For example, honey may be applied to the top of the plurality of perforations 127a . . . 127n. As liquid, such as tea or other drink, is sucked from a bottom of the drinking straw 100 to the top of the drinking straw 100, the liquid enters the reservoir 103 and comes into contact with the honey. The liquid sweetened by the honey thereby proceeds through the top portion 112 of the reservoir 103 and out the first elongated tube portion 106 into the mouth of the operator.

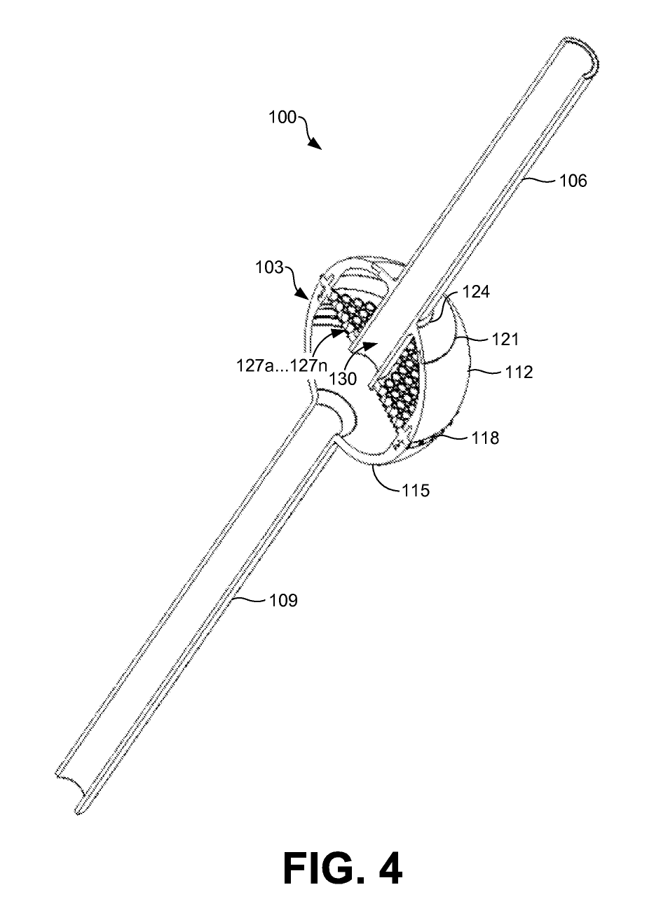

Referring next to FIG. 4, shown is a cross-section view of the drinking straw 100 according to various embodiments of the present disclosure. As noted above, the drinking straw 100 may comprise a first elongated tube portion 106 and a second elongated tube portion 109, where the second elongated tube portion 109 may be used for placement into a liquid while the first elongated tube portion 106 may be used for insertion into a mouth of an operator to induce suction of the liquid through the drinking straw 100. The reservoir 103 of the drinking straw 100 may be disposed between the first elongated tube portion 106 and the second elongated tube portion 109 where the reservoir 103 is configured to cause the liquid being sucked through the first elongated tube portion 106 and the second elongated tube portion 109 to mix with a substance, such as a sweetening agent, retained in the reservoir 103 as liquid flows through the drinking straw 100.

For purposes of explanation, an interior cross-section of the reservoir 103 is shown in FIG. 4. In various embodiments, the perforated disc 118 may comprise a disc or other surface that conforms to the shape of the reservoir 103 where an agent, such as honey, sugar, tea bags, liquid dye, or other similar agent, is retained for coming into contact with a liquid. The perforated disc 118 includes perforations 127a . . . 127n or holes that channel liquid from the bottom portion 115 to the top portion 112 of the reservoir 103 when suction is induced in the first elongated tube portion 106. Further, the top portion 112 of the drinking straw 100 may be detachably attached to the first elongated tube portion 106 via a tube base 121 that is configured to detach from the top portion 112. To this end, a bottom end 130 of the first elongated tube portion 106 may extend beyond the tube base 121 and through a recess 133 in the perforated disc of the perforated disc 118. The tube base 121 may comprise the receptacle 124 configured to receive the first elongated tube portion 106. Further, the tube base 121 may be configured to snap into or otherwise detachably attach to a recess 136 of the top portion 112 of the reservoir 103.

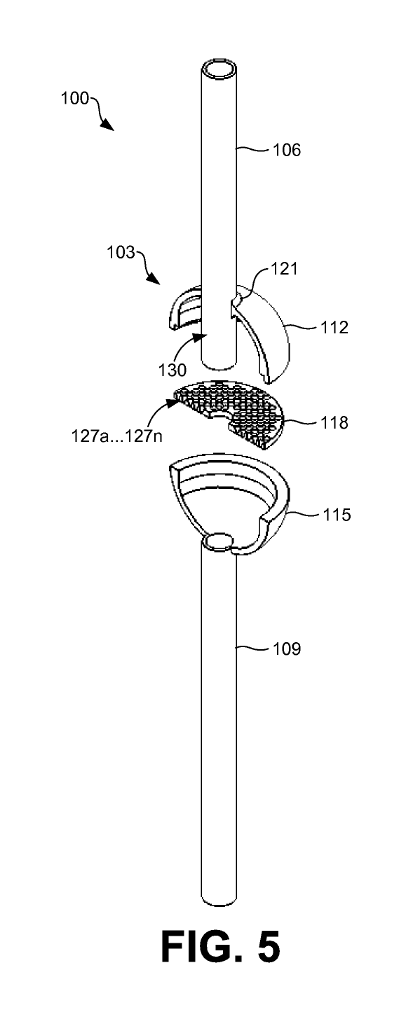

Moving on to FIGS. 5, 6, 7, 8, and 9, shown are cross-section views of the drinking straw 100 according to various embodiments of the present disclosure. As noted above, the drinking straw 100 may comprise a first elongated tube portion 106 and a second elongated tube portion 109, where the second elongated tube portion 109 may be used for placement into a liquid while the first elongated tube portion 106 may be used for insertion into a mouth of an operator to induce suction of the liquid through the drinking straw 100. The reservoir 103 of the drinking straw 100 may be disposed between the first elongated tube portion 106 and the second elongated tube portion 109 where the reservoir 103 is configured to cause the liquid being sucked through the first elongated tube portion 106 and the second elongated tube portion 109 to mix with a substance, such as a sweetening agent, retained in the reservoir 103 as liquid flows through the drinking straw 100.

In various embodiments, the perforated disc 118 may comprise a disc or other surface that conforms to the shape of the reservoir 103 where an agent, such as honey, sugar, tea bags, liquid dye, or other similar agent, is retained for coming into contact with a liquid. The perforated disc 118 includes perforations 127a . . . 127n or holes that channel liquid from the bottom portion 115 to the top portion 112 of the reservoir 103 when suction is induced in the first elongated tube portion 106. Further, the top portion 112 of the drinking straw 100 may be detachably attached to the first elongated tube portion 106 via a tube base 121 that is configured to detach from the top portion 112. To this end, a bottom end 130 of the first elongated tube portion 106 may extend beyond the tube base 121 and through a recess 133 in the perforated disc of the perforated disc 118. The tube base 121 may comprise the receptacle 124 configured to receive the first elongated tube portion 106. Further, the tube base 121 may be configured to snap into or otherwise detachably attach to a recess 136 of the top portion 112 of the reservoir 103.

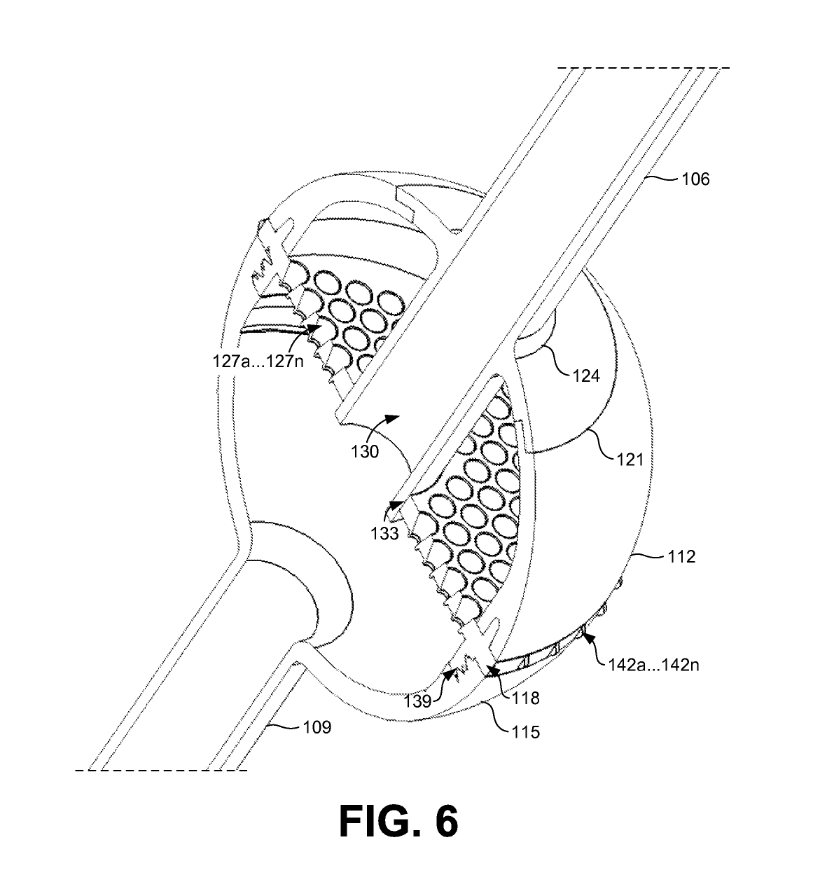

As shown in FIGS. 6, 7, 8, and 9, individual ones of the perforations 127a . . . 127n may comprise a conical channel, wherein a first end (e.g., a top) of the conical channel is wider than a second end (e.g., a bottom) of the conical channel. In some embodiments, the first end (e.g., a top) of the conical channel may be less than or equal to the width of the second end (e.g., a bottom) of the conical channel. FIG. 6 also depicts threads 139 that illustrate that a top portion 112 and/or a bottom portion 115 of the reservoir 103 may be attached to one another by virtue of being screwed into the perforated disc 118. In other words, the perforated disc 118 of the drinking straw 100 is detachably attached to the top portion 112 and the bottom portion 115 of the reservoir 103.

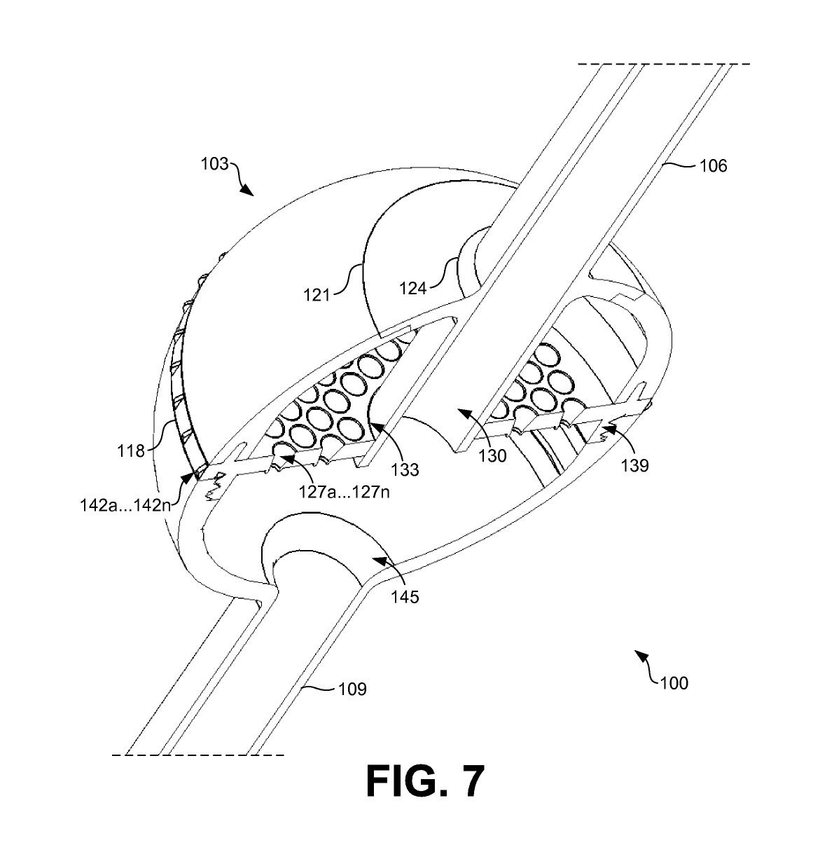

Further, FIGS. 6 and 7 illustrate that at least a portion of the perforated disc 118 may be exposed to an environment when the perforated disc 118 is disposed between the bottom portion 115 and the top portion 112 of the reservoir 103, for example, when the drinking straw 100 is fully assembled. The exposed portion may comprise a plurality of ridges 142a . . . 142n or other projections that facilitate gripping the perforated disc 118 to unscrew and/or disassemble the reservoir 103. In some embodiments, the first elongated tube portion 106 may extend into or beyond the top portion of the reservoir 103, for example, by being received in the recess 133 of the perforated disc 118. To this end, in some embodiments, the circumference of the recess 133 may be substantially similar to the circumference of the bottom end 130 of the first elongated tube portion 106.

FIG. 7 also illustrates a reservoir transition 145 where the second elongated tube portion 109 meets the reservoir 103. The reservoir transition 145 may comprise an annular and tapered region that facilitates the drain of liquid from the reservoir 103. In various embodiments, the reservoir transition 145 comprises a component of the second elongated tube portion 109 while, in other embodiments, the reservoir transition 145 comprises a component of the bottom portion 115 of the reservoir 103.

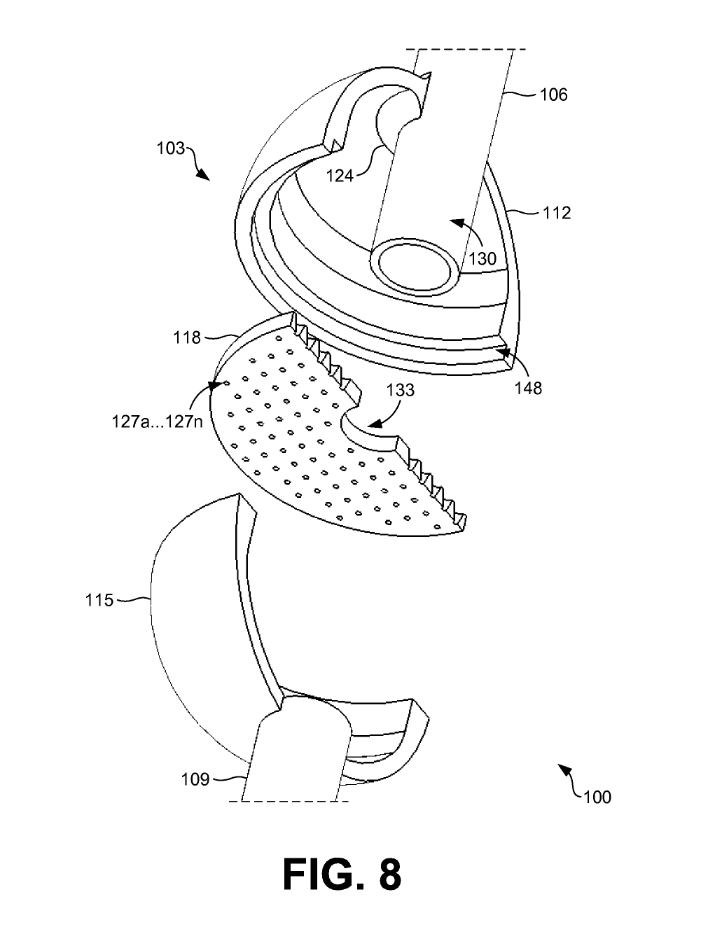

FIG. 8 illustrates that the bottom of the conical channels of the perforations 127a . . . 127n are narrower or smaller than the top of the conical channels. Further, FIG. 8 depicts that a niche 148 in a bottom of the top portion 112 that allows the perforated disc 118 to conform to the top portion 112 when assembled. In further embodiments, a top of the bottom portion 115 may comprise a similar niche that receives the perforated disc 118 that secures and restricts movement of the perforated disc 118 when the drinking straw 100 is fully assembled.

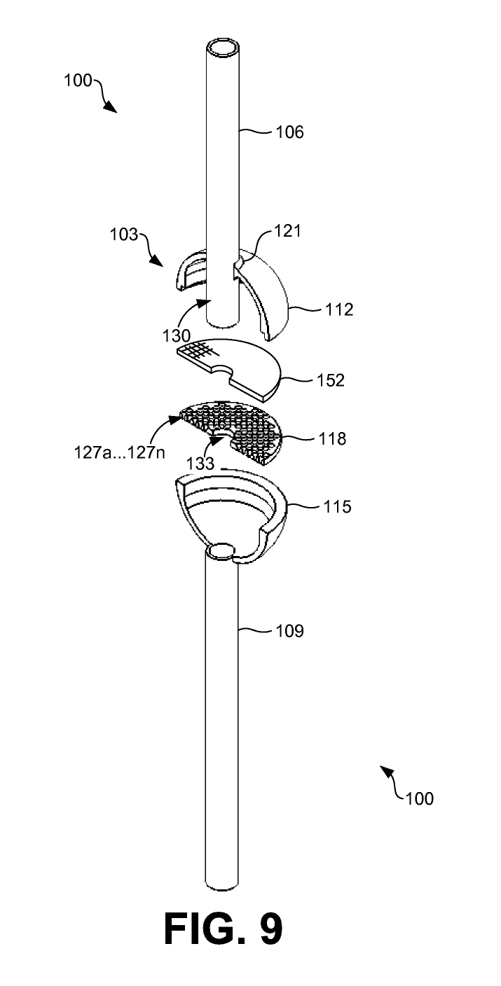

FIG. 9 shows that an agent 152 may be included in an interior of the reservoir 103, for example, on a top of the perforated disc 118. In various embodiments, the agent 152 may be disc-shaped or shaped to substantially conform to the shape of the perforated disc 118. In some embodiments, the agent 152 comprises a sweetening agent, such as a disc formed of honey, sugar, artificial sweeteners, and/or other sweeteners. In other embodiments, the agent 152 may comprise a tea bag that, when mixed with water, creates tea as the drinking straw 100 is used.

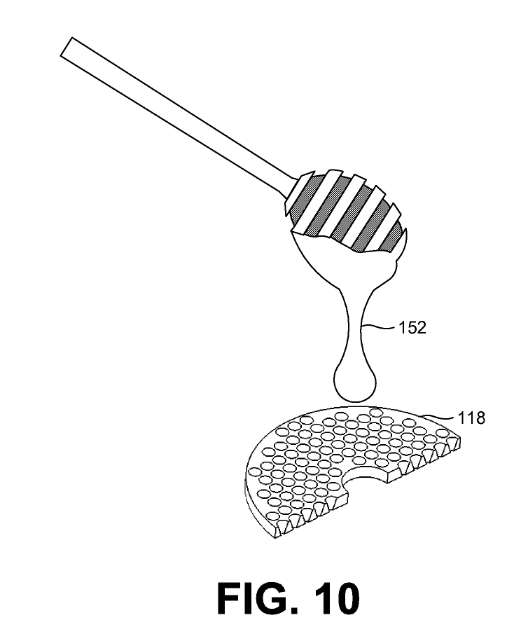

FIG. 10 shows that the agent 152 may be liquid or substantially liquid. In such embodiments, the agent 152 may be applied by pouring the agent 152 onto a surface of the perforated disc 118 (cross-section shown) prior to assembly of the drinking straw 100.

As described above, the drinking straw 100 may be used as a drinking apparatus to infuse an agent or ingredient, such as honey, into a liquid, such as tea, during a consumption of the liquid. An individual may first insert the second elongated tube portion 109 inside of a cup or other container containing a liquid. The perforations 127 on the perforated disc 118 allow the beverage to mix with the agent 152 as the beverage is consumed. Honey or another ingredient may be added by pouring the honey onto the perforated disc 118. The drinking straw 100 may be inserted through a notch into a lid of a drink container, as may be appreciated.

The embodiments described herein improve the consistency of sweetening the beverage, especially for cold beverages. In addition, the present embodiment may prevent the honey from clogging the drinking straw 100 since the honey is elevated away from recesses of the elongated tube portions 106/109. Moreover, the individual may spend less time cleaning the drinking straw 100 than traditional drinkers that use honey to sweeten their drinks. After the individual is finished with their beverage, a majority of the remaining honey will be located on the perforated disc 118. The individual may remove the perforated disc 118 and wash the honey or other substance off of the surface.

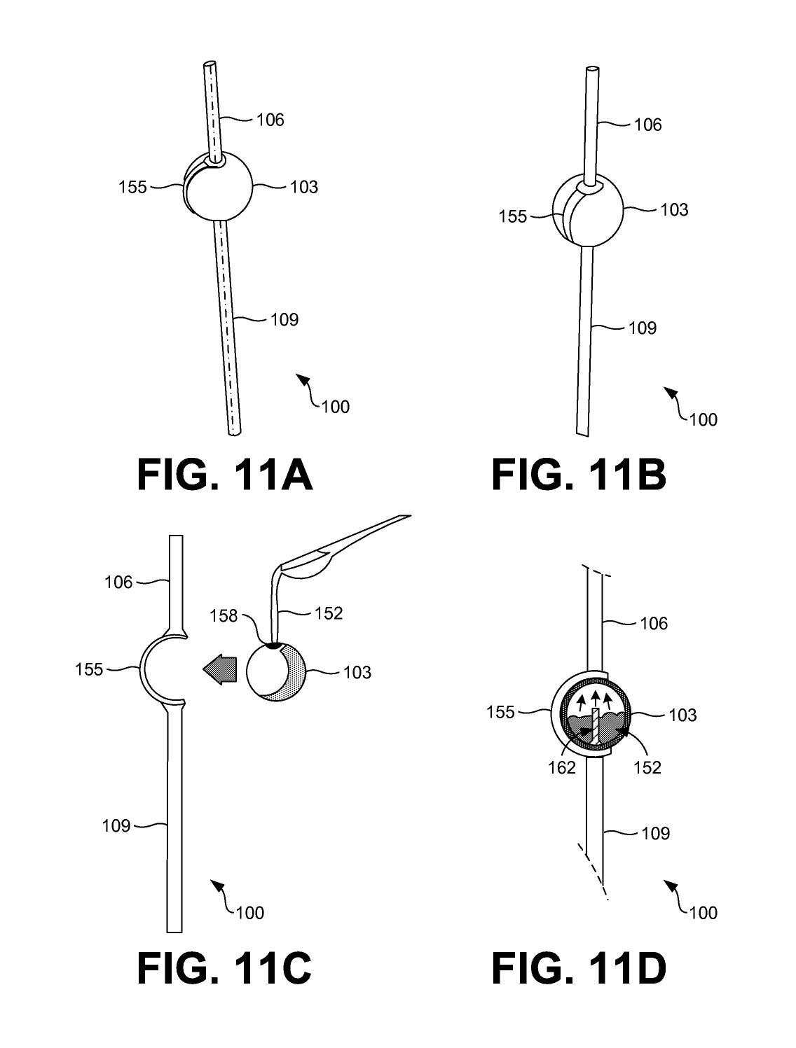

With reference to FIGS. 11A-11D, shown are non-limiting examples of using the reservoir 103 as a cartridge, where the reservoir 103 can be removed independent from the first elongated tube portion 106 and the second elongated tube portion 109. As may be appreciated, the reservoir 103 may retain and dissolve a drinking substance into a beverage or other liquid during consumption. In the embodiments shown in FIGS. 11A-11D, the first elongated tube portion 106 and the second elongated tube portion 109 are connected by a gap attachment 155 configured to retain the reservoir 103. Accordingly, in various embodiments, the reservoir 103 may be removed from or inserted into the gap attachment 155. As may be appreciated, the gap attachment 155 may comprise portals, holes, or recesses that align with those of the first elongated tube portion 106 and the second elongated tube portion 109 such that the gap attachment 155 does not impede or otherwise interfere with the flow of liquid through the drinking straw 100. When inserted, the gap attachment 155 may snap the reservoir 103 into a secure position. As shown in FIG. 11C, the reservoir 103 may comprise a portal 158 where an agent 152, such as honey, can be poured into an interior of the reservoir 103. In some embodiments, the reservoir 103 comprises an inner tube 162 where an individual may pour honey until the level of honey in the reservoir 103 is near the height of the inner tube 162.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z each be present.

Therefore, the following is claimed:

1. A drinking straw, comprising:
a first elongated tube portion for insertion into a mouth of an operator to induce suction;
a second elongated tube portion for placement into a liquid; and
a reservoir disposed between the first elongated tube portion and the second elongated tube portion, the reservoir being configured to mix the liquid with a sweetening agent as liquid flows from the second elongated tube portion through the reservoir and the first elongated tube portion into the mouth of the operator, wherein the reservoir comprises:
a top portion coupled to the first elongated tube portion;
a bottom portion coupled to the second elongated tube portion; and
a perforated disc disposed between the top portion and the bottom portion, the perforated disc being configured to receive the sweetening agent, thereby causing the liquid flowing through the reservoir to come into contact with the sweetening agent prior to introduction in the first elongated tube portion.

2. The drinking straw of claim 1, wherein the perforated disc comprises a plurality of perforations that channel the liquid from a bottom portion of the reservoir to a top portion of the reservoir.

3. The drinking straw of claim 2, wherein individual ones of the plurality of perforations comprise a conical channel, wherein a first end of the conical channel is wider than a second end of the conical channel.

4. The drinking straw of claim 1, wherein the perforated disc is detachably attached to the top portion and the bottom portion.

5. The drinking straw of claim 1, wherein at least a portion of the perforated disc is exposed to an environment when the perforated disc is disposed between the bottom portion and the top portion.

6. The drinking straw of claim 1, wherein the perforated disc is detachably attached to the top portion and the bottom portion.

7. The drinking straw of claim 1, wherein the first elongated tube portion extends into the top portion of the reservoir and is received in a recess of the perforated disc.

8. The drinking straw of claim 1, further comprising a sweetening agent positioned on a surface of the perforated disc.

9. The drinking straw of claim 1, wherein the sweetening agent further comprises a circular shaped disc.

10. The drinking straw of claim 1, wherein the first elongated tube portion is detachably attached to the top portion or the second elongated tube portion is detachably attached from the bottom portion.

11. An apparatus, comprising:
a first elongated tube portion for insertion into a mouth of an operator to induce suction;
a second elongated tube portion for placement into a liquid; and
a reservoir disposed between the first elongated tube portion and the second elongated tube portion, the reservoir being configured to mix the liquid with a sweetening agent as liquid flows from the second elongated tube portion through the reservoir and the first elongated tube portion into the mouth of the operator.

12. The apparatus of claim 11, wherein the reservoir comprises:
a top portion coupled to the first elongated tube portion;
a bottom portion coupled to the second elongated tube portion; and
a perforated disc disposed between the top portion and the bottom portion, the perforated disc being configured to receive the sweetening agent, thereby causing the liquid flowing through the reservoir to come into contact with the sweetening agent prior to introduction in the first elongated tube portion.

13. The apparatus of claim 12, wherein the perforated disc comprises a plurality of perforations that channel the liquid from a bottom portion of the reservoir to a top portion of the reservoir.

14. The apparatus of claim 13, wherein individual ones of the plurality of perforations comprise a conical channel, wherein a first end of the conical channel is wider than a second end of the conical channel.

15. The apparatus of claim 12, wherein the perforated disc is detachably attached to the top portion and the bottom portion.

16. The apparatus of claim 12, wherein at least a portion of the perforated disc is exposed to an environment when the perforated disc is disposed between the bottom portion and the top portion.

17. The apparatus of claim 12, wherein the perforated disc is detachably attached to the top portion and the bottom portion.

18. The apparatus of claim 12, wherein the first elongated tube portion extends into the top portion of the reservoir and is received in a recess of the perforated disc.

19. The apparatus of claim 12, further comprising a sweetening agent positioned on a surface of the perforated disc.

20. The apparatus of claim 12, wherein the first elongated tube portion is detachably attached to the top portion or the second elongated tube portion is detachably attached from the bottom portion.
